(19) United States
(12) Patent Application Publication
(10) Pub. No.: US 2014/0008296 A1
(43) Pub. Date: Jan. 9, 2014

(54) SEPTIC TANK MONITORING SYSTEM

(71) Applicants: Laura Mills, Raytown, MO (US); Michael R. Mills, Raytown, MO (US)

(72) Inventors: Laura Mills, Raytown, MO (US); Michael R. Mills, Raytown, MO (US)

(21) Appl. No.: 13/540,614

(22) Filed: Jul. 3, 2012

(51) Int. Cl. C02F 3/28; G01F 23/34

(52) U.S. Cl. 210/614; 210/123; 210/86; 73/314

(57) ABSTRACT

A septic tank monitoring system is disclosed. The system can include a septic tank gauge having a float disposed within a housing, the housing having a first magnetic switch and a second magnetic switch, the float having a magnet adapted to activate the first magnetic switch when the float is at a first level and to active the second magnetic switch when the float is at a second level. The system can also include a controller adapted to receive a signal from each of the first magnetic switch and the second magnetic switch, and to activate an auto-dialer in response to a signal from the first magnetic switch, and to activate a water supply shut off valve in response to a signal from the second magnetic switch.

### FIELD

Embodiments relate generally to septic systems and, more particularly, to a septic tank gauge and monitoring system and method.

### BACKGROUND

Septic tanks are commonly used to handle sewage in areas where city or county sewer service may not be available. If liquid in a septic tank fills to a level at or above the incoming sewer drain line, the sewer drain line may back up and cause potentially harmful sewage to flood a house or building. A sewage flood can be hazardous to the health of people and animals, and can also cause extensive property damage.

Embodiments were conceived in light of the above-mentioned problems and limitations, among other things.

### SUMMARY

One embodiment includes a septic tank monitoring system. The system can have a septic tank gauge having a float disposed within a housing, the housing having one or more proximity sensors (e.g., a first magnetic switch and a second magnetic switch), the float can have a magnet adapted to activate the first magnetic switch when the float is at a first level and to active the second magnetic switch when the float is at a second level. The system can also include a controller adapted to receive a signal from each of the first magnetic switch and the second magnetic switch, and to activate an auto-dialer in response to a signal from the first magnetic switch, and to activate a water supply shut off valve in response to a signal from the second magnetic switch.

Another embodiment includes a method for monitoring a septic tank. The method can include monitoring, at a control module, a first signal and a second signal from a septic tank gauge. The method can also include activating an auto-dialer when the first signal indicates that a level of liquid in the septic tank being monitored has reached a first level. The method can further include activating a water supply line shut off valve when the second signal indicates that a level of liquid in the septic tank has reached a second level.

One embodiment includes a septic tank gauge having a float disposed within a housing. The housing can have a at least one proximity sensor (e.g., a first magnetic switch and a second magnetic switch), the float can include a magnet adapted to activate the first magnetic switch when the float is at a first level and to active the second magnetic switch when the float is at a second level.

### BRIEF DESCRIPTION OF THE DRAWINGS

FIG. 1 is a flowchart of an example method for septic tank monitoring in accordance with at least one embodiment.

FIG. 2 is a diagram of a septic tank monitoring system in accordance with at least one embodiment.

FIG. 3 is a diagram of a septic tank having an example septic tank gauge in accordance with at least one embodiment.

FIG. 4 is a diagram of a septic tank with a liquid level at a first alert level of an example septic tank gauge in accordance with at least one embodiment.

FIG. 5 is a diagram of a septic tank with a liquid level at a second alert level of an example septic tank gauge in accordance with at least one embodiment.

FIG. 6 is a diagram of an example septic tank gauge in accordance with at least one embodiment.

FIG. 7 is a perspective view of an example locking ring assembly in accordance with at least one embodiment.

FIG. 8 is a perspective view of an example filter assembly in accordance with at least one embodiment.

FIG. 9 is a diagram of an example septic gauge and connector in accordance with at least one embodiment.

### DETAILED DESCRIPTION

In general, a method and apparatus for monitoring septic tank inflow and outflow (via liquid level), and can help prevent back flow of raw sewage to the inlet side of the septic tank.

A float moves up and down inside a housing, utilizing two proximity switches attached to the housing and a rare earth magnet attached to the float to monitor the liquid level of raw sewage inside a septic tank. The two proximity switches are wired with low voltage wiring to a control /dialer box and to a water solenoid located on the main water line coming into the structure (e.g., house, office, or other structure). Once the first proximity switch is tripped, from a pre-determined liquid level for the septic tank, the control box can activate the dialer to call one or more pre programmed phone numbers to warn of problems with the septic tank. If the second proximity switch is tripped, it activates the water solenoid, shutting off the water to the structure and/or activates the dialer to call the programmed numbers to inform that the water has been shut-off.

The movement of the float is controlled by the liquid level in the tank itself. When the float rises to a predetermined level, the magnet in the float opens (or closes) the proximity switch that runs to the monitoring box to active the dialer. The dialer then calls preprogrammed telephone numbers to alert the customer (or other party responsible or interested party) that a problem may exist with the septic tank and that the tank may require servicing.

If the float reaches the second proximity switch, it opens (or closes) and activates the monitoring box to activate the water solenoid to shut off the main water line and, optionally, to activate the dialer to call the preprogrammed telephone numbers to alert the customers that the septic tank has reached a dangerous level, the water supply line to the structure has been shut-off and that the septic tank may need to be serviced before the water can be turned back on in order to help prevent damaging or dangerous conditions.

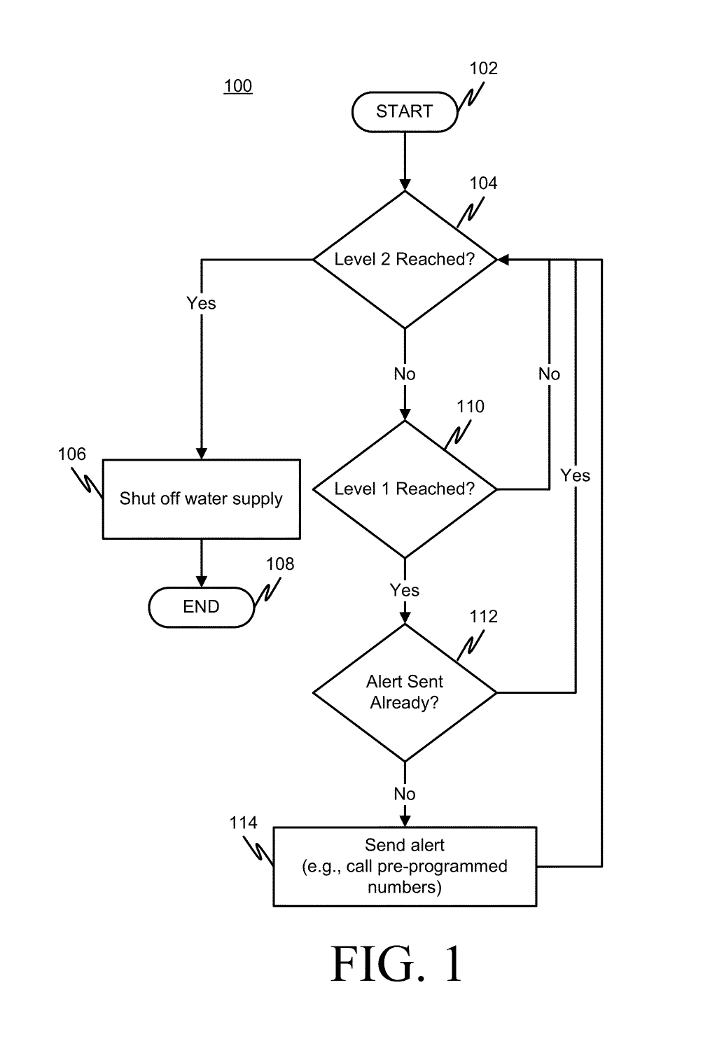

FIG. 1 is a flowchart of an example method 100 for septic tank monitoring in accordance with at least one embodiment. The method begins at 102 and continues to 104.

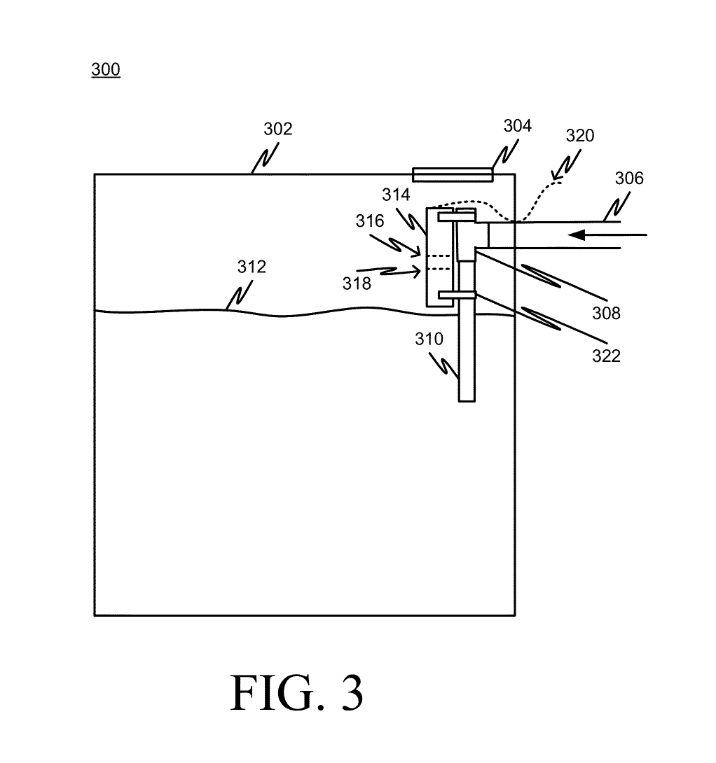

At 104, a system determines if level 2 has been reached. Level 2 can correspond, for example, to a level just below (e.g., about 2 inches) an incoming sewage line of a septic tank. Level 2 can be indicated by a sensor such as a septic tank gauge described below in connection with FIGS. 3-8. If level 2 has been reached, the process continues to 106. If level 2 has not been reached the process continues to 110.

At 106, a water supply line is shut off in response to liquid in a septic tank reaching level 2. For example, the system can activate a water supply shut off valve, such as a solenoid valve on an incoming water main line. This will reduce or eliminate additional sewage or waste water from flowing into the septic tank from a house or other building connected to the septic tank. The process continues to 108, where processing ends. The system may remain in the water line shut off state until reset (e.g., by a plumber) or until the liquid level in the septic tank is reduced below level 2, at which point monitoring may resume.

At 110, the system determines if level 1 has been reached. For example, level 1 can correspond to a liquid level below the second level that can be used to trigger an alert that the liquid level in the septic tank is approaching a potentially unsafe level at which the sewage may flow back into the sewage drain line from the house or other building connected to the septic tank. If the liquid level in the septic tank has reached level 1, then processing continues to 112. If the liquid level in the septic tank has not reached level 1, then processing returns to 104.

At 112, the system determines if an alert relating to level 1 has already been sent. If so, processing returns to 104. If not, processing continues to 114.

At 114, an alert is sent to inform a person or other system that the liquid level in the septic tank may be rising to an unsafe level. For example, the system can activate an auto-dialer (e.g., AD-2001 manufactured by United Security Products, Inc. of Poway, Calif.) that will dial one or more phone numbers and deliver a message to inform someone about the condition of the liquid level in the septic tank. For example, the auto-dialer could be programmed to call the home owner or building owner, a plumber and any other person that may be interested in the maintenance of the house or building. The auto-dialer could send the alert via placing a phone call, sending a short message service (SMS) text message to a mobile phone, sending an email, sending a chat message, sending a fax, or the like. Also the system could indicate level 1 being reached via a visual and/or audible alert such as an indicator light or buzzer. Once the alert has been sent, the process continues back to 104.

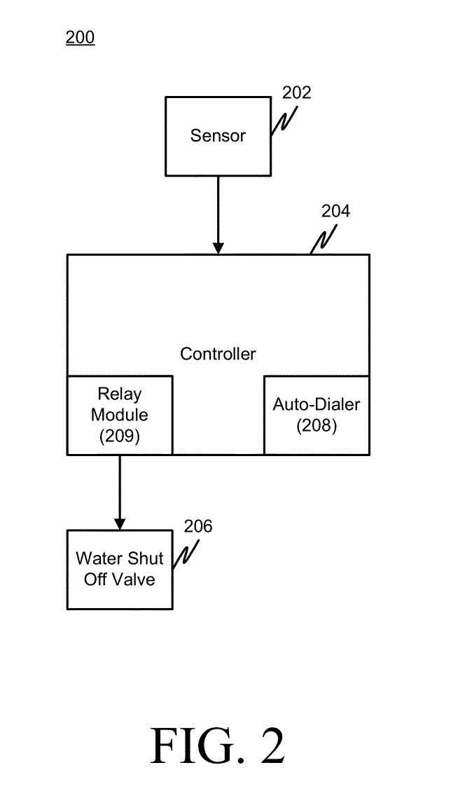

FIG. 2 is a diagram of a septic tank monitoring system 200 in accordance with at least one embodiment. In particular, the system 200 includes a sensor 202 (e.g., the septic tank gauge described below), a controller 204, a water supply line shut off valve 206 and an auto-dialer 208.

In operation, the controller 204 performs monitoring functions (e.g., as described above in connection with FIG. 1) and controls the water shut off valve 206 (e.g., via optional relay module 209) and the auto-dialer 208 in response to the liquid level in the septic tank being monitored. The controller can include an electrical controller, a programmable computer-based controller 204 or the like. The controller 204, the auto-dialer 208 and the relay module 209 can be separate components or can be integrated together in one or more assemblies. The relay module can be a standard alarm relay module such as the ELK-912 manufactured by ELK Products, Inc. of Hildebrand, N.C. It will be appreciated that any suitable relay controllers, relay modules or auto-dialers can be used.

FIG. 3 is a diagram of a septic tank system 300 having an example septic tank gauge in accordance with at least one embodiment. In particular, the septic system 300 includes a septic tank 302, an access panel 304, an incoming water supply line 306, a tee connector 308, a liquid line 310, a liquid level 312, a septic tank gauge 314, a second level 316, a first level 318, signal lines 320 and connectors 322.

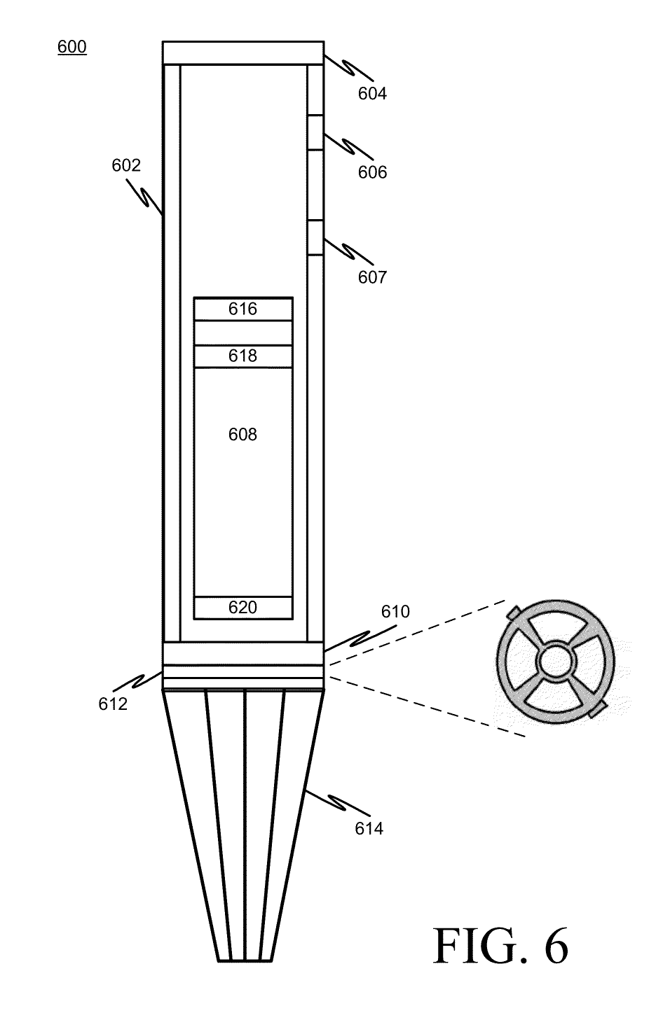

The septic tank gauge 314 is described in greater detail below in connection with FIGS. 6-8.

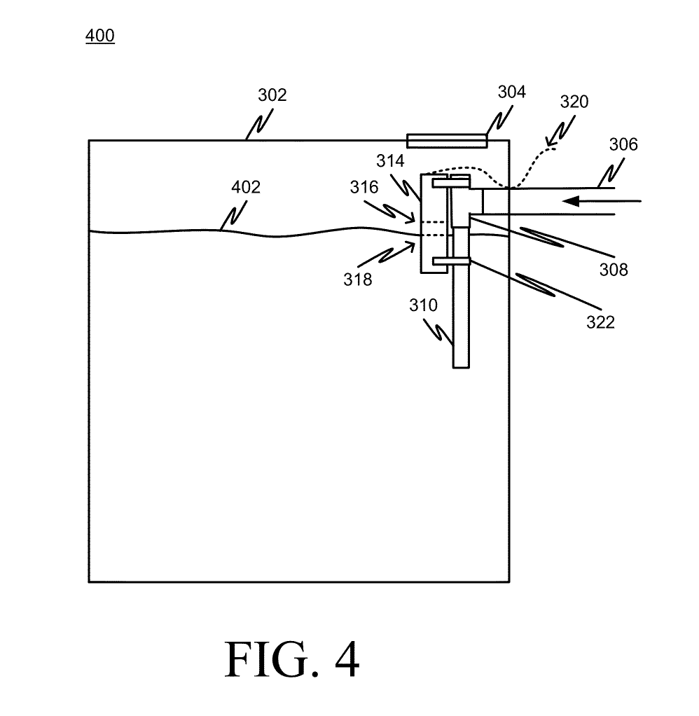

FIG. 4 is a diagram of a septic tank 400 with a liquid level at a first alert level 402.

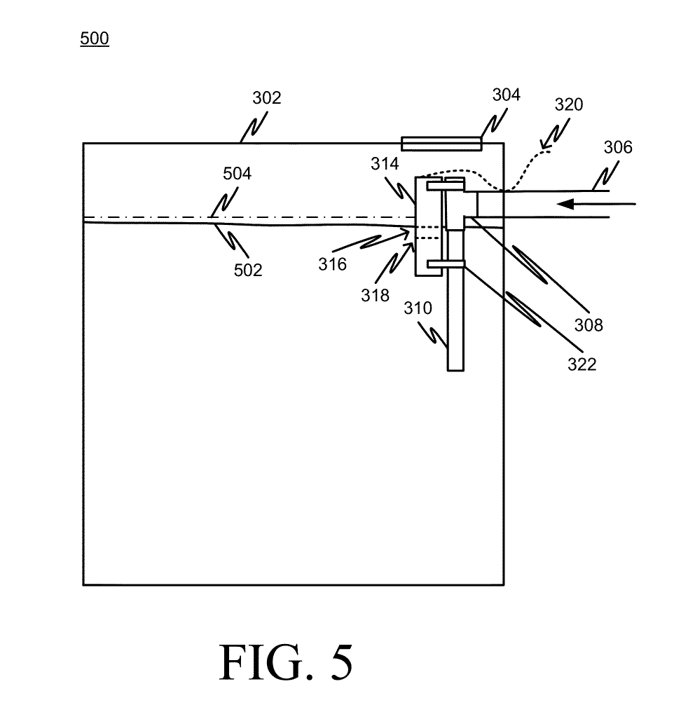

FIG. 5 is a diagram of a septic tank 500 with a liquid level at a second alert level 502. It can be seen that the second alert level 502 is below the bottom level 504 of the incoming sewage drain line.

FIG. 6 is a diagram of an example septic tank gauge 600 in accordance with at least one embodiment. The gauge 600 includes a housing 602, a top cap 604, a second proximity switch 606, a first proximity switch 607, a float 608, a housing locking connector element 610, a filter locking connector element 612, a filter 614. The float 608 includes a top cap 616, an actuating element 618 and a bottom cap 620.

In operation, the float 608 floats at a level of liquid in the septic tank. If the float reaches a level such that the actuating element 618 in the float activates the first proximity switch 607, a signal is received by the controller (described above) and an action is taken in response to the liquid level reaching level 1. If the actuating element 618 in the float reaches the second proximity switch 606, another signal is sent to the controller and a different action is taken in response to the liquid in the septic tank reaching level 2. The filter 614 is used to help prevent solids or other contaminants from clogging the housing 602 and preventing the float from freely travelling inside the housing 602.

The proximity switches 607 and 606 can be placed in the wall of the housing 602, on an outside of the housing 602 or on an inside of the housing 602. The proximity switches (or sensors) 607 and 606 can be magnetic switches or another known or later developed proximity sensor. The actuating element 618 can be a magnet adapted to activate a magnetic switch (e.g., proximity switches 607 and 606).

The housing locking connector element 610 and the filter locking connector element 612 are adapted and configured to keep the filter 614 releasably locked to the housing.

The top cap 604 can be removable for servicing the septic tank gauge 600 and can include one or more holes to vent gas from the housing.

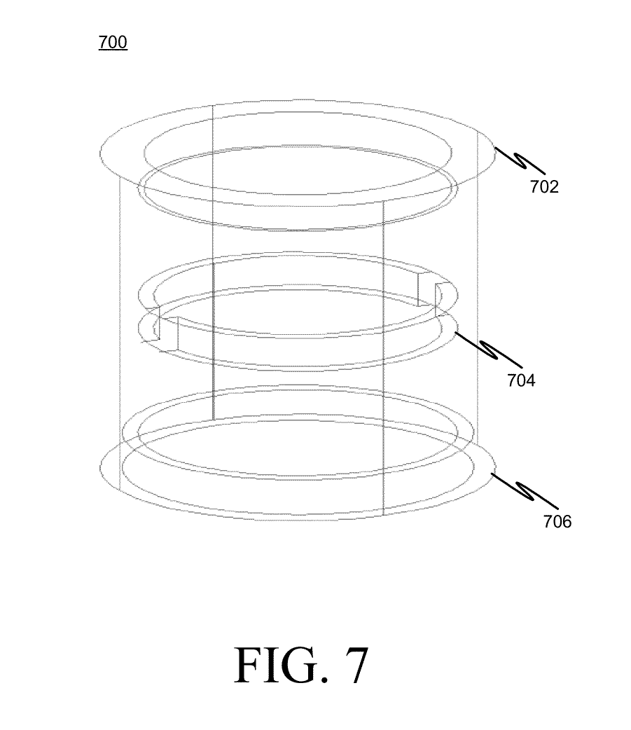

FIG. 7 is a perspective view of an example locking connector assembly 700 in accordance with at least one embodiment. In particular, the locking connector assembly includes a housing element 702 that is connected to the housing (not shown) of the septic tank gauge, a intermediate element 704 and a filter element 706 coupled to the filter.

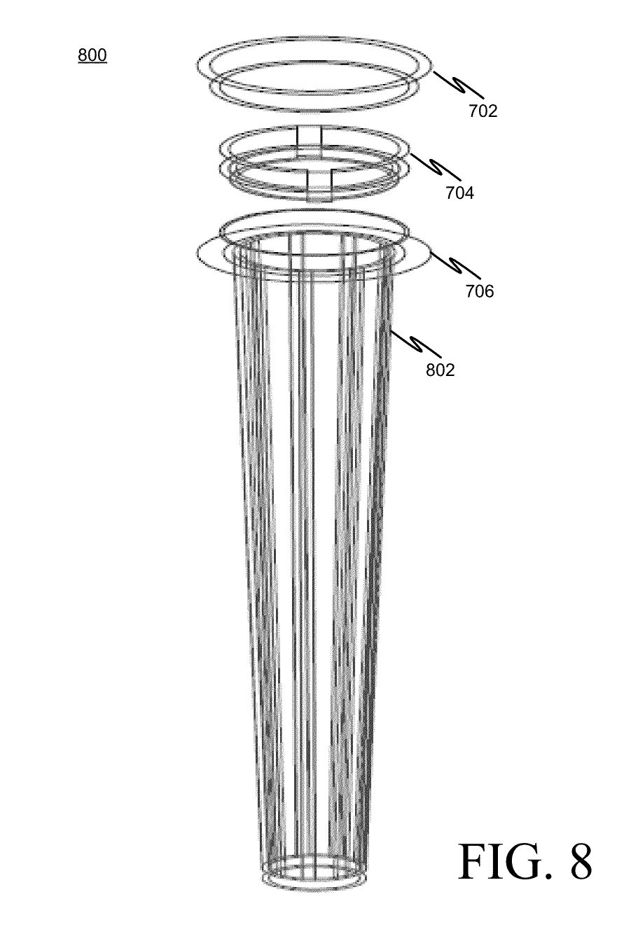

FIG. 8 is a perspective view of an example filter assembly 800 in accordance with at least one embodiment. The filter assembly 800 includes a housing element 702 that is connected to the housing (not shown) of the septic tank gauge, a intermediate element 704 and a filter element 706 coupled to a filter 802.

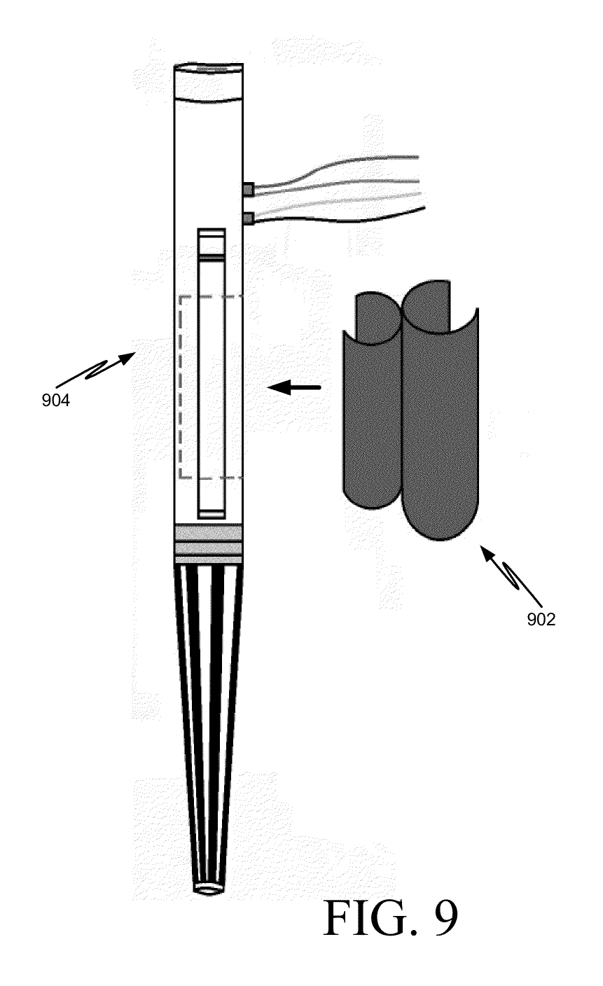

FIG. 9 shows an example connector 902 and septic gauge 904. One side of the connector 902 can be fastened (e.g., glued or the like) to the septic gauge 904 and the other side can be fastened to the incoming water line T connector, pipe or other suitable structure.

It is, therefore, apparent that there is provided, in accordance with the various embodiments disclosed herein, a septic tank monitoring system and method.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A septic tank monitoring system comprising:
a septic tank gauge having a float disposed within a housing, the housing having a first magnetic switch and a second magnetic switch, the float having a magnet adapted to activate the first magnetic switch when the float is at a first level and to active the second magnetic switch when the float is at a second level; and
a controller coupled to the septic tank gauge and adapted to receive a signal from each of the first magnetic switch and the second magnetic switch, the controller further adapted to activate an auto-dialer when the signal from the first magnetic switch indicates the float as reached the first level, and to activate a water supply shut off valve when the signal from the second magnetic switch indicates that the float has reached the second level.

2. The system of claim 1, wherein the septic tank gauge includes a filter coupled to a bottom end of the housing via a locking connector.

3. The system of claim 1, wherein the housing includes a removable cap disposed at a top end of the housing.

4. The system of claim 1, wherein the septic tank gauge is adapted to be connected to an incoming sewage line of a septic tank.

5. The system of claim 1, wherein the second level is below a bottom edge of an incoming water line of the septic tank when the septic tank gauge is installed and the first level is below the second level.

6. The system of claim 1, wherein the auto-dialer is adapted to be programmed to dial at least one phone number and deliver a message.

7. The system of claim 1, wherein the auto-dialer is adapted to deliver a text message via one or more of a short message service and electronic mail.

8. The system of claim 1, wherein the water supply shut off valve is an electrically activated solenoid valve.

9. A method for monitoring a septic tank, the method comprising:
monitoring, at a control module, a first signal and a second signal from a septic tank gauge;
activating an auto-dialer when the first signal indicates that a level of liquid in the septic tank being monitored has reached a first level; and
activating a water supply line shut off valve when the second signal indicates that a level of liquid in the septic tank has reached a second level.

10. The method of claim 9, wherein the first signal and second signal are supplied by a septic tank gauge having a float disposed within a housing, the housing having a first magnetic switch and a second magnetic switch, the float having a magnet adapted to activate the first magnetic switch when the float is at a first level and to active the second magnetic switch when the float is at a second level, the first magnetic switch supplying the first signal and the second magnetic switch supplying the second signal.

11. The method of claim 10, wherein the septic tank gauge includes a filter coupled to a bottom end of the housing via a locking connector.

12. The method of claim 10, wherein the housing includes a removable cap disposed at a top end of the housing.

13. The method of claim 10, wherein the septic tank gauge is adapted to be connected to an incoming sewage line of a septic tank.

14. The method of claim 10, wherein the second level is below a bottom edge of an incoming water line of the septic tank when the septic tank gauge is installed and the first level is below the second level.

15. The method of claim 10, wherein the auto-dialer is adapted to be programmed to dial at least one phone number and deliver a message.

16. The method of claim 10, wherein the auto-dialer is adapted to deliver an electronic message via one or more of a short message service and electronic mail.

17. The method of claim 10, wherein the water supply shut off valve is an electrically activated solenoid valve.

18. A septic tank gauge comprising:
a float disposed within a housing, the housing having at least one proximity switch, the float having an actuating element adapted to activate the at least one proximity switch when the float is at a first level, wherein the at least one proximity switch includes a second proximity switch and wherein the second proximity switch is activated when the float is at a second level.

19. The septic tank gauge of claim 18, further comprising a filter coupled to a bottom end of the housing via a locking connector.

20. The septic tank gauge of claim 18, wherein the second level is below a bottom edge of an incoming water line of the septic tank when the septic tank gauge is installed and the first level is below the second level.
